(19) United States
(12) Patent Application Publication
(10) Pub. No.: US 2015/0081578 A1
(43) Pub. Date: Mar. 19, 2015

(54) SYSTEM AND METHOD FOR BEHAVIORAL PROGRAM SELECTION AND ADMINISTRATION

(71) Applicant: Hartford Fire Insurance Company, Hartford, CT (US)

(72) Inventors: Kelly J. McLaughlin, Cobalt, CT (US); Cindy Kate Roth Sides, Laguna Beach, CA (US)

(73) Assignee: Hartford Fire Insurance Company, Hartford, CT (US)

(21) Appl. No.: 14/086,564

(22) Filed: Nov. 21, 2013

Related U.S. Application Data
(60) Provisional application No. 61/878,390, filed on Sep. 16, 2013.

(51) Int. Cl. G06Q 10/10

(52) U.S. Cl. CPC G06Q 10/1057
USPC 705/322

(57) ABSTRACT

A system for determining, for selected insurance groups, a behavior modification program for modifying a first select behavior comprises an insurance database storing employee and claims data including workers compensation class for employees of a plurality of insurance groups, one or more insurance processors, an insurance memory in communication with the one or more insurance processors and storing insurance program instructions, and an insurance communications device. One or more of the plurality of insurance groups are selected for participation in the first behavior modification program. One or more employees are selected for participation from the one or more of the plurality of insurance groups selected for participation in the first behavior modification program. A first behavior modification program membership data file is updated for each insurance group and information about the behavior modification program is transmitted to the groups selected for participation.

### CROSS-REFERENCE TO RELATED APPLICATIONS

This application claims benefit of and priority to U.S. Provisional Patent Application Ser. No. 61/878,390, filed Sep. 16, 2013, entitled System And Method for Obesity Program Selection and Administration, the entirety of which is incorporated herein by reference for all purposes.

### FIELD

Embodiments relate to systems and methods to facilitate the selection of insurance groups and employees of the insurance groups for participation and enrollment in behavioral modification programs.

### BACKGROUND

Insurance company data indicates that overweight and obese workers, compared to healthy weight workers, have (1) a higher rate of workers compensation (“WC”) claim filings; (2) a higher rate of lost workdays; (3) higher medical claims costs; and (4) higher indemnity claims costs. Furthermore, insurance company data indicates that obese claimants have a higher total severity of WC claims and lower claim disposal rates. Similarly, workers with pain management issues, compared to workers without pain, also have a higher rate of WC filings, lost workdays, medical claim costs, and higher medical claim costs. Insurance company data can help identify workers or individuals who are more susceptible to having workers compensation or group benefits claims for various behavioral reasons.

Conventional “wellness” programs have been instituted by companies to address weight control and other employee health issues with that drive up workers compensation and other group benefits costs. However, recent research indicates that such wellness programs do not appear to be effective in reducing costs related to employee weight control.

Accordingly, a different approach is needed to effectively target insurance groups and individual employees of those insurance groups who require assistance to deal with specific behavioral issues that may lead to an increased frequency and severity of claims.

### SUMMARY

In embodiments, systems and computer-implemented methods are provided for determining behavior modifications programs for selected insurance groups. In an embodiment, a system includes an insurance database for storing employee data including workers compensation class and claims data for employees of a plurality of insurance groups; one or more insurance processors; an insurance memory in communication with the one or more insurance processors and storing insurance program instructions, the one or more insurance processors operative with the program instructions to: select, based on the employee data and the claims data, one or more of the plurality of insurance groups for participation in a first behavior modification program; select one or more employees of the one or more of the plurality of insurance groups for participation in a first behavior modification program; update a first behavior modification program membership data file for each insurance group to include information identifying the one or more employees of the one or more insurance groups selected for participation in the first behavior modification program. The system may also include an insurance communications device for transmitting, to each of the insurance groups selected for participation in the first behavior modification program, information relating to the first behavior modification program.

In embodiments, a computer-implemented method for providing a weight control program to selected insurance groups includes: selecting, based on the employee data, the claims data, and workers compensation class, one or more of the plurality of insurance groups for participation in a first behavior modification program; selecting one or more employees of the one or more of the plurality of insurance groups for participation in a first behavior modification program; updating a first behavior modification program membership data file for each insurance group to include information identifying the one or more employees of the one or more insurance groups selected for participation in the first behavior modification program; and transmitting, using an insurance communication device, to each of the insurance groups selected for participation in the weight control program, information relating to the weight control program and information relating to the discounts.

### BRIEF DESCRIPTION OF THE DRAWINGS

FIG. 1A illustrates a system architecture within which some embodiments may be implemented.

FIG. 1B illustrates a system architecture within which some embodiments may be implemented.

FIG. 2A is a partial functional block diagram of an insurance computer system to determine insurance groups and individuals for participation and enrollment in a behavior modification program.

FIG. 2B is a partial functional block diagram of an insurance computer system to determine insurance groups and individuals for participation and enrollment in a behavior modification program.

FIGS. 3, 4A, and 4B illustrate a flow diagram of a process according to some embodiments.

FIG. 5 is a partial functional block diagram of an administration computer system to provide employees with access to a behavior modification program, monitor usage of the program, and receive health data.

FIG. 6 illustrates a flow diagram of a process according to some embodiments.

FIG. 7 shows an exemplary system screen of an illustrative embodiment of the present invention.

FIG. 8 shows an exemplary database of an illustrative embodiment of the present invention.

FIG. 9 shows an exemplary report of an illustrative embodiment of the present invention.

### DETAILED DESCRIPTION

Disclosed herein are processor-executable methods, computing systems, and related technologies for the administration, management and communication of behavior modification programs, including in embodiments the administration, management and communication of a behavior modification program for a selected behavior. Using the behavior modification programs, insurers may be able to reduce the incidence and severity of particular types of workers compensation and group benefits claims, and policyholders may be able to receive discounts on their workers compensation and group benefits premiums. For example, in an embodiment, a weight control behavior program may be offered to particular insurance groups identified as groups that would benefit from such a program. In embodiments, participation of employees of the insurance groups in the program may make the insurance groups eligible for premium discounts. In other embodiments, eligibility for premium discounts may be based on factors such as the effectiveness of the program. In another example, in an embodiment a pain management behavior program may be offered to particular insurance groups identified as groups that would benefit from such a program. Individual employees who would benefit from the programs may be identified, and discounts may be available to the policyholders based on participation or effectiveness of the program.

Embodiments of the present system and method may be more effective than broad-based wellness programs because such embodiments target the provision of behavioral modification programs for selected behaviors engaged in by employees at the specific insurance groups or selected behaviors that are expected to occur at the specific insurance groups. As used herein, the term “behavior” is used to refer to the way in which individual employees conduct themselves. Specific types of behavior refer to the way in which individual employees or groups of employees (for example, a group of employees within an insurance group) conduct themselves with respect to the specific behavior. For example, weight control behavior may refer to the way in which an employee (or group) conducts him/herself with respect to weight control. Other types of behavior include, but are not limited to, employee safety behavior, prescription management behavior, rehabilitation management behavior, cognitive behavior, fitness behavior, pain management behavior, and sophisticated medical consumer training behavior. Employee safety behavior may refer to the way in which an employee conducts him/herself or a group conducts itself with regards to safety at their place of employment. Prescription management behavior may refer to the way in which an employee conducts him/herself or a group conducts itself with regards to taking prescription drugs, such as whether the employee takes the drugs on time and as directed. Rehabilitation management behavior may refer to the way in which an employee conducts him/herself or a group conducts itself with regards to the rehabilitation of employees who have sustained an injury, such as whether the employee participates in recommended therapy. Cognitive behavior may refer to the way in which an employee conducts him/herself or a group conducts itself with regards to treatment of maladjusted behavior or dysfunctional behavior. Fitness behavior may refer to the way in which an employee conducts him/herself or a group conducts itself with regards to keeping healthy and fit. Pain management behavior may refer to the way in which an employee conducts him/herself or a group conducts itself with regards to treating pain. Sophisticated medical consumer training behavior may refer to the way in which an employee conducts him/herself or a group conducts itself with regards to making medical purchasing and treatment decisions.

As will be understood, more than one type of behavior may apply to a particular employee or group of employees. For example, an individual employee may, in relation to an injury, require prescription drugs, rehabilitation, and pain management. The way in which the employee conducts him/herself with respect to each aspect individually, may, in embodiments, determine what type of behavioral modification program is best suited for the employee, or if the employee requires more than one type of program. In some circumstances, the employee may exhibit acceptable behavior with the prescription drug and pain management portions of their treatment, but may struggle with the rehabilitation portion. In other circumstances, the employee may exhibit acceptable behavior with the rehabilitation portion of treatment, but struggle with the prescription drugs and pain management portion of their treatment. In an embodiment, all three types of behavioral modification programs may be made available to the policy holder for use by their employees. In another embodiment, specific programs are made available for the behaviors that are most represented in the group score for an insurance group.

Mounting evidence from workers compensation claims data has identified that targeted behavioral programs may be successful in reducing the frequency and severity of employee claims. For example, evidence demonstrates that treating chronic pain with prescription opioid painkillers for months and years not only fails to help the injured workers regain function but also exposes the workers to additional medical problems. A pain management behavior modification program or a prescription drug behavior modification program can offer less dangerous and less expensive methodologies to manage employee pain, restore function, and help them return to work sooner. Likewise, employees with weight issues often have higher claim frequency and disability duration, therefore targeted control behavior management programs may help reduce the number and severity of claims by overweight or obese employees. By way of further example, studies have indicated that new employees with less than a year of work tenure have a much higher probability of injury than employees with more experience, in certain workers compensation classes such as those that include construction and manufacturing. Similarly, other studies have identified older construction workers as having a higher incidence of high-severity claims. Thus a safety behavior modification program may be effective if it is targeted at workers in certain workers compensation classes, and may be targeted at workers with less than a year experience and older workers. Other behavioral modification programs may be targeted similarly.

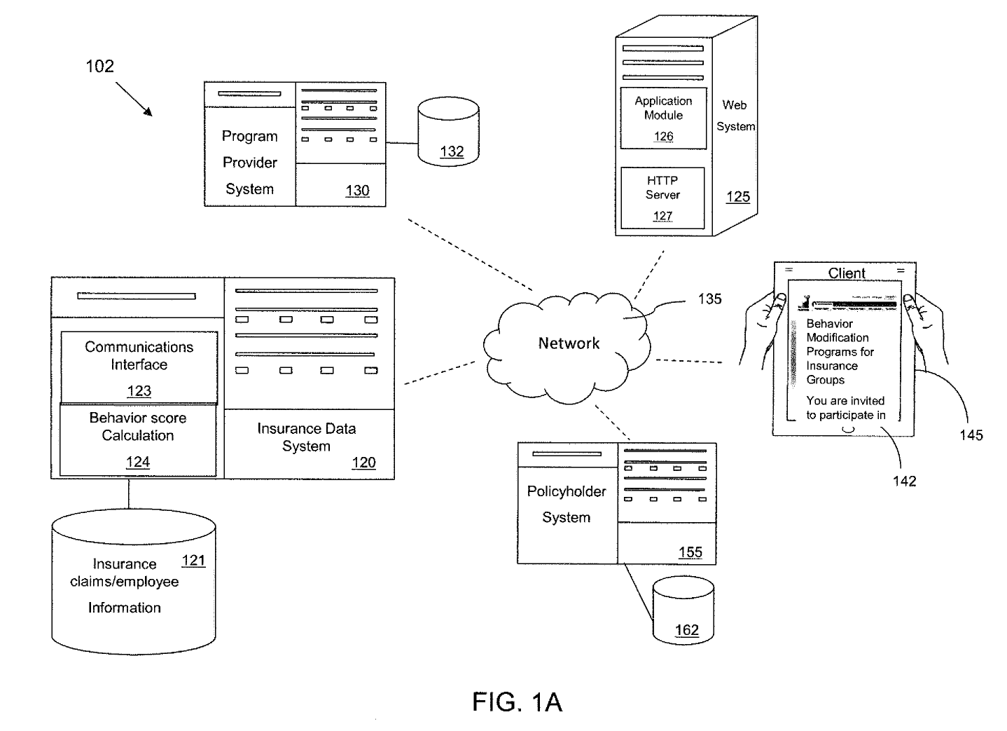

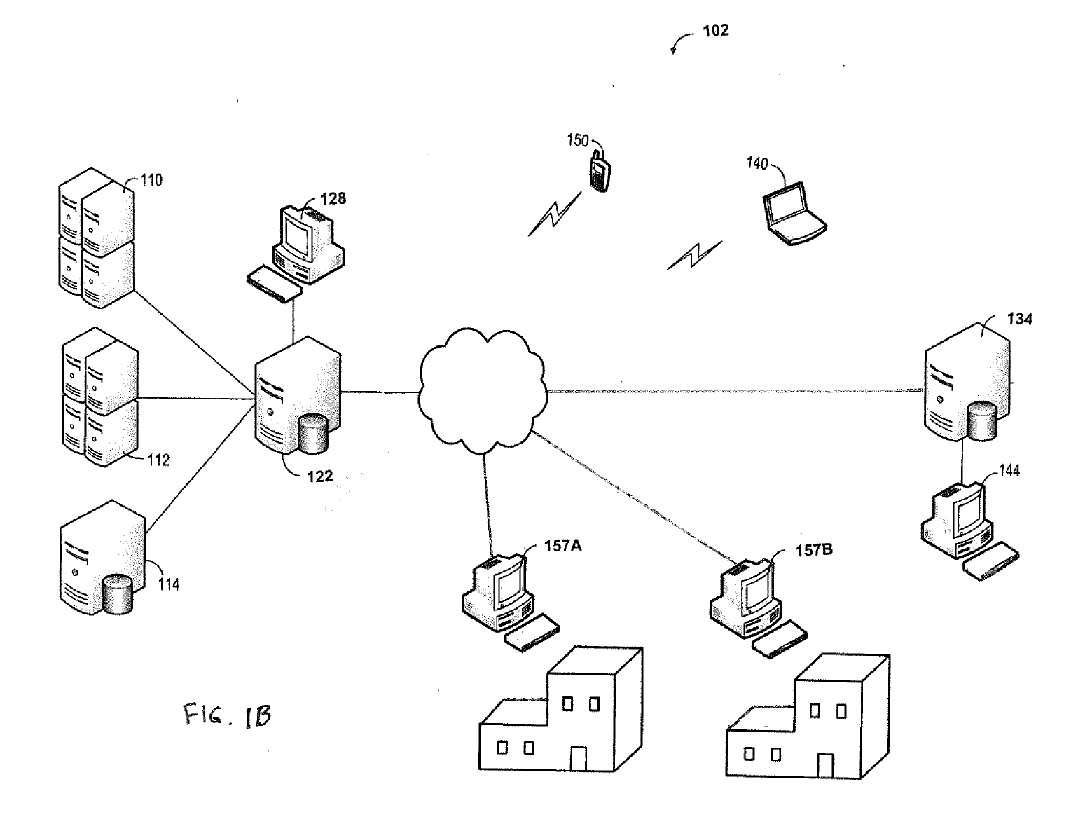

FIG. 1A shows an embodiment of an example architecture 102 that may be used for the administration and management of behavioral modification programs in an illustrative embodiment of the present invention. The behavioral modification programs to be offered may be identified by an insurance company, offered to a policyholder, prepared and administered by an administrator, and participated in by employees. The example architecture 102 may include an insurance system 120, a web system 125, an employee device 145, a network 135, a system of a provider of behavioral modification program or programs 130, and policy holder system 155. Program provider system 130 may also include a database 132. In the example architecture 102 of FIG. 1A, the insurance system 120 and the program provider system 130 may be under the separate control of an insurance/financial services company and a third party program provider. In other embodiments, insurance system 120 may be integrated with program provider system 130, with both insurance system 120 and program provider system 130 being under the control of an insurance entity.

Referring still to FIG. 1A, the insurance system 120 may include a communications interface module 123, a behavior score calculation module 124, and an insurance claims information and employee information database 121. The behavior score calculation module 124 may include one or more software modules or objects and one or more specific-purpose processor elements to perform the calculations and processing required by embodiments of the present invention such as for calculating the group scores for selected behaviors, the trend in the group scores for selected behaviors, the individual employee behavior scores, and the trend in the individual employee behavior scores. In some embodiments, the behavior score calculation module 124 may also include one or more business rules and one or more predictive models. The business rules may provide guidelines on how to score insurance groups and individuals based on certain types of employee, insurance group, claims history information for workers compensation claims and group benefits claims, workers compensation experience modifiers for the insurance groups and individuals, demographic claims data of insurance groups in the same industry and geographic region, and demographic workers compensation experience modifiers. Other business rules may be implemented in accordance with embodiments of the present invention. The behavior score calculation module 124 may include or access one or more look-up tables that correlate behaviors to scores.

In operation, the behavior score calculation module 124 may receive insurance group or employee data including the workers compensation class of the employees in the insurance groups, claims history data such as workers compensation claims data and group benefits claims data, and workers compensation experience modifiers for the insurance groups and individuals. The behavior score calculation module 124 may also receive demographic claims data of insurance groups in the same industry and geographic region, and demographic workers compensation experience modifiers. The behavior score calculation module 124 may then calculate scores for groups, individual employees, and trends in scores based on the data.

The behavior score calculation module 124 in conjunction with the web server 125 may output information for transmission to one or more insurance groups that have been identified as potentially benefiting from one or more of the behavioral modification programs. In an embodiment, the information may include an invitation to one or more insurance groups selected for participation in one or more behavioral programs. In another embodiment, the information may include discounts available to each of the selected insurance groups, which may include discounts on the price for the program itself and premium discounts for successful completion of the programs.

The insurance information database 121 may store information such as certain types of employee data including employee job descriptions, employee age, employee weight, employee height, employee geographic data, and employee workers compensation class. The insurance information database 121 may also in embodiments store information such as insurance groups information including the employees in the groups, claims history information for workers compensation claims and group benefits claims, workers compensation experience modifiers for the insurance groups and individuals, demographic claims data of insurance groups in the same industry and geographic region, and demographic workers compensation experience modifiers. Insurance information database 116 may include data stored in one or more computer-readable storage media, and may be or include one or more relational databases, hierarchical databases, object-oriented databases, one or more flat files, one or more spreadsheets, and/or one or more structured files. Insurance information database 116 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

Communication between the insurance system 120 and the other elements in the example architecture 102 of FIG. 1A may be performed via the communications interface module 123 interacting with network 135. In an example, the insurance system 120 may also interface with third party systems and third party data, not shown, which may include for example demographic workers compensation and group benefits claims data and workers compensation experience modifiers, for different industries and geographic regions. In an embodiment, insurance system 120 may interface with computer systems such as policyholder system 155 associated with one or more companies who hold workers compensation and/or group benefits policies with the insurance company, and program provider computer systems such as program provider system 130.

Referring still to FIG. 1A, the program provider system 130 may perform functionality such as providing and administering behavioral modification programs. For example, the program provider system 130 may make available one or more programs to employees of insurance groups selected for participation in the behavioral programs. In embodiments, the program provider system 130 may also administer and track the usage, progress, and completion of programs by the employees using the programs. The program provider system 130 may store the programs and administration information in a program database 132. The program database 132 may also include data stored in one or more computer-readable storage media, and may be or include one or more relational databases, hierarchical databases, object-oriented databases, one or more flat files, one or more spreadsheets, and/or one or more structured files. As will be described in further detail below, the insurance system 120 may use information from the program database 132 to provide information such as invitations to participate in the programs to insurance groups and employees in the insurance groups.

Referring still to FIG. 1A, a web site system 125 may provide a web site that may be accessed directly by an insurance group such as an insured company or employees of the insurance group operating a user client device 145. User client device 145 can include, but is not limited to cellular telephones, other wireless communication devices, personal digital assistants, pagers, laptop computers, tablet computers, smartphones, or combinations thereof. A user client device 145 may be part of a system or network of a third party, such as an insured company holding a policy from the insurance company. In the illustrative embodiment of the present invention, user client device 145 may communicate with the web site system 125 that may be operated by or under the control of an insurance entity or other third party entity such as an outsourced type program provider entity or a third party administrator entity or program provider administrator entity. The web site system 125 may generate one or more web pages for access by client device 145, and may receive responsive information from the client device 145 such as insurance group purchase of behavioral programs and usage information from employees participating in the behavioral programs through their client devices. The responsive information may include information that identifies the user, information related to the product(s) that the user is viewing, purchasing, or requesting, and/or other related types of information. The web site system 125 may then communicate this information to the program provider system 130 for processing. The web site system 125 may also communicate one or more web pages to the client device 145 that provide one or more behavior programs that may be suitable for the insurance group or employee user from the provider system 130.

In operation, client device 145 may be used to approve and/or select one or more of the programs that an insurance group is invited to participate in, and in embodiments may be used to select particular employees to participate in particular programs. Selection via client device 145 may be accomplished via a touch-sensitive touch screen that provides an input interface and an output interface between the client device 145 and the client or user. The client device 145 displays visual output to the user for manipulation by the user. The visual output may include checkboxes, radio buttons, graphics, text, icons, video, and any combination thereof. The touch screen may display one or more graphics within the user interface displayed on device 145. In this embodiment, as well as others, a user may select one or more of the graphical elements by making contact or touching the graphics, for example, with one or more fingers or stylus implements.

The web site system 125 may include a web application module 126 and a HyperText Transfer Protocol (HTTP) server module 127. The web application module 126 may generate the web pages that make up the web site and that are communicated by the HTTP server module 127. The web application module 126 may be implemented in and/or based on a technology such as Active Server Pages (ASP), PHP: Hypertext Preprocessor (PHP), Python/Zope, Ruby, any server-side scripting language, and/or any other appropriate technology.

The HTTP server module 127 may implement the HTTP protocol, and may communicate HyperText Markup Language (HTML) pages and related data from the web site to/from the consumer client device 145 using HTTP. The HTTP server module 127 may be, for example, a Sun-ONE Web Server, an Apache HTTP server, a Microsoft Internet Information Services (IIS) server, and/or may be based on any other appropriate HTTP server technology. The web site system 125 may also include one or more additional components or modules (not depicted), such as one or more switches, load balancers, firewall devices, routers, and devices that handle power backup and data redundancy.

Referring still to FIG. 1A, the client device 145 may include a web browser module 142, which may communicate data related to the web site to/from the HTTP server module 127 and the web application module 126 in the web site system 125. The web browser module 142 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 142 may implement Rich Internet Application (RIA) and/or multimedia technologies such as Adobe Flash, Microsoft Silverlight, and/or other technologies. The web browser module 142 may implement RIA and/or multimedia technologies using one or web browser plug-in modules (such as, for example, an Adobe Flash or Microsoft Silverlight plugin), and/or using one or more sub-modules within the web browser module 142 itself. The web browser module 142 may display data on one or more displays that are included in or connected to the client device 145, such as a liquid crystal display (LCD) display, organic light-emitting diode (OLED) display, touch screen or monitor. The client device 145 may receive input from the user of the client device 145 from input devices (not depicted) that are included in or connected to the client device 145, such a mouse or other pointing device, or a touch screen, and provide data that indicates the input to the web browser module 142.

The example architecture 102 of FIG. 1A may also include one or more wired and/or wireless networks within network 135 via which communications between the elements 120, 125, 130, 145, and 155 in the example architecture 100 may take place. The networks may be private or public networks, and/or may include the Internet. In one example deployment scenario, the insurance system 120, web site system 125, program provider system 130 and company system 155 may communicate via one or more private networks that are under the control of the financial services/insurance company, while the client device 145 may communicate with the web site system 125 via the Internet.

Each or any combination of the modules 123, 124, 126, and 127 shown in FIG. 1A may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1A, these modules 123, 124, 126, and 127 shown may perform functionality described later herein.

FIG. 1B illustrates another system architecture 100 within which some embodiments may be implemented. Although some devices of architecture 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. A variety of communications protocols may be employed in architecture 100, including but not limited to: Ethernet, SAP, SAS™, ATP, Bluetooth, GSM and TCP/IP. Networks facilitating communications within architecture 100 may be or include wired or wireless local area networks and wide area networks, cellular telephone networks, and the Internet.

Moreover, each device may comprise any number of hardware and/or software elements suitable to provide the functions described herein as well as any other functions. Other topologies may be used in conjunction with other embodiments.

According to the example of FIG. 1B, insurance databases 110 through 114 store policy and claims information associated with insurance policies, for individuals or for insurance groups. Policy information may include any combination of policy-related data fields that are or become known, including but not limited to policy type, policy number, insured name, deductibles, coverage limits, riders and exceptions, and information on employees covered by the policy (e.g., name, age, states of employment and residence, periodic compensation amounts, job classifications, and other data) in the case of workers compensation or group benefit policies. Each of databases sources 110, 112, and 114 may comprise any combination of hardware and/or software, including but not limited to relational databases, application servers, and spreadsheets. In an embodiment, one or more of insurance databases 110 through 114 may comprise a policy issuing system, a weight control (or other behavioral program) program recommendation system, a data warehouse of an insurance company, or any other aggregator of insurance policy information. In an alternate embodiment, one or more of the insurance databases 110 through 114 may comprise employee data for employees covered by policies, and one or more of the insurance databases 110 through 114 may comprise claims data for claims filed by employees covered by policies. In other embodiments, there may be separate insurance databases for policy information, employee information, and claims information. In addition, different databases may be used to store information about different types of policies. For example, one database may store information relating to workers compensation policies while a separate database may store information relating to group benefits policies.

Each of insurance databases 110 through 114 may provide policy information to system 122 asynchronously or according to any schedule. In some embodiments, one or more of insurance databases 110 through 114 provides a daily feed of policy information to system 122. The policy information of the feed may be associated with new insurance policies for which an initial premium has been paid.

System 122 may comprise any combination of hardware and software to perform processes as described herein, and may include one or more computer processors. According to some embodiments, system 122 receives employee data and claims data associated with a plurality of insurance groups from one of databases 110 through 114, determines a group score for a behavior for each of the plurality of insurance groups based on the employee data and claims data, determines a trend in the group score for the behavior for each of the plurality of insurance groups, selects one or more of the plurality of insurance groups for participation in the behavior modification program, determines discounts available to each of the insurance groups selected for participation in the behavior modification program, and transmits to each of the selected insurance groups information about the behavior modification program and the discounts. Details of the foregoing process and additional processes are provided below.

As will be described below, system 122 may comprise a plurality of data structures, such as relational database tables. System 122 may also comprise program instructions of a database management system, database procedures and/or database applications to process the data stored in the data structures. Terminal 128 may be operated to edit this data and to otherwise provide commands to system 122. For example, terminal 128 may be operated to update a data structure including information associated with a third-party administrator of a behavior modification program. Such an update may change the telephone number associated with the third-party administrator of the behavior modification program or costs associated with behavior modification programs offered by the third-party administrator and the like. Terminal 128 may comprise any suitable device, including but not limited to a desktop computer, laptop computer, notebook, smart phone, tablet, personal digital assistant or other device.

Administrative system 134 may be linked to system 122 through a network such as the internet or in other embodiments may be connected to system 122 through other known networking technologies. Administrative system 134 may be part of the insurance company or in an other embodiment may be part of a third party, such as a third party provider of behavior modification programs to employees. Administrative system 134 may receive from system 122 a behavior modification program membership data file for each insurance group selected for participation in the behavior modification program. Administrative system 134 may then provide access to the behavior modification program to the selected employees through employee devices. Employee devices may include any equipment owned by an employee that is able to access behavior modification program, such as computers, personal digital assistants, computer tablets, laptop computers, smart phones, or smart televisions. Employee devices may also include devices that are accessed by the employee at their employer's business, such as a laptop or desktop computer used by the employee. Administrative system 134 may track usage of the behavior modification program by each employee, and may transmit, via the administrative communications device, the usage data to the one or more insurance processors.

In an embodiment, administrative system 134 may receive health data from the employees selected to participate in the behavior modification program. Health data may include health information provided by an employee on a computer 140 or on a smart phone 150 to the administrative system 134 through the world wide web, and according to some embodiments health data can be provided by electronic mail or facsimile. Health data may also include human telematics data, such as movement data that may be provided by smart phone applications that use, for example, motion sensors in the phone to sense movement by an employee. In another embodiment, one or more employees may wear devices (not shown on FIG. 1B) for obtaining telematics data such as heart rate monitors, pedometers, and any other type of sensor that is able to sense movement or health conditions (e.g., heart rate, pulse) of the employee. The health data devices may be permanently or intermittently connected to the administrative system 134 through the internet or other network to transmit detected telematics data to the administrative system 134.

Administrative system 134 may have one or more computers 144 to enable administration of a behavior modification program and to control access to the behavior modification program. All computers described herein may comprise any suitable devices for requesting and displaying user interfaces, including but not limited to desktop computers, cellular telephones, personal digital assistants, and laptops.

Businesses covered by workers compensation or insurance group policies issued by the insurance company may have computers such as computers 157A and 157B that are communicatively coupled to system 122 and administrative system 134. Computers 157A and 157B are representative of two such computers and it is understood that there may be many more businesses with computers connected to an insurance system 122 and it is also understood that a single business may have more than one computer connected to insurance system 122. The term “business” as used herein includes any employer, and includes non-profit and governmental organizations and units as well as for profit business enterprises and divisions and units thereof, by way of example. Computers 157A and 157B may receive information concerning behavior modification programs and potential premium discounts for participating in such programs. In an embodiment, the information may be received from system 122, and in an alternate embodiment the information may be received from system 134. In an embodiment, computers 157A and 157B may be computers at a business that may be used by employees enrolled in a behavior modification program to access the program.

It should be noted that embodiments are not limited to the devices illustrated in FIG. 1B. Each device may include any number of disparate hardware and/or software elements, some of which may be located remotely from one another. Functions attributed to one device may be performed by one or more other devices in some embodiments. The devices of system 100 may communicate with one another (and with other non-illustrated elements) over any suitable communication media and protocols that are or become known.

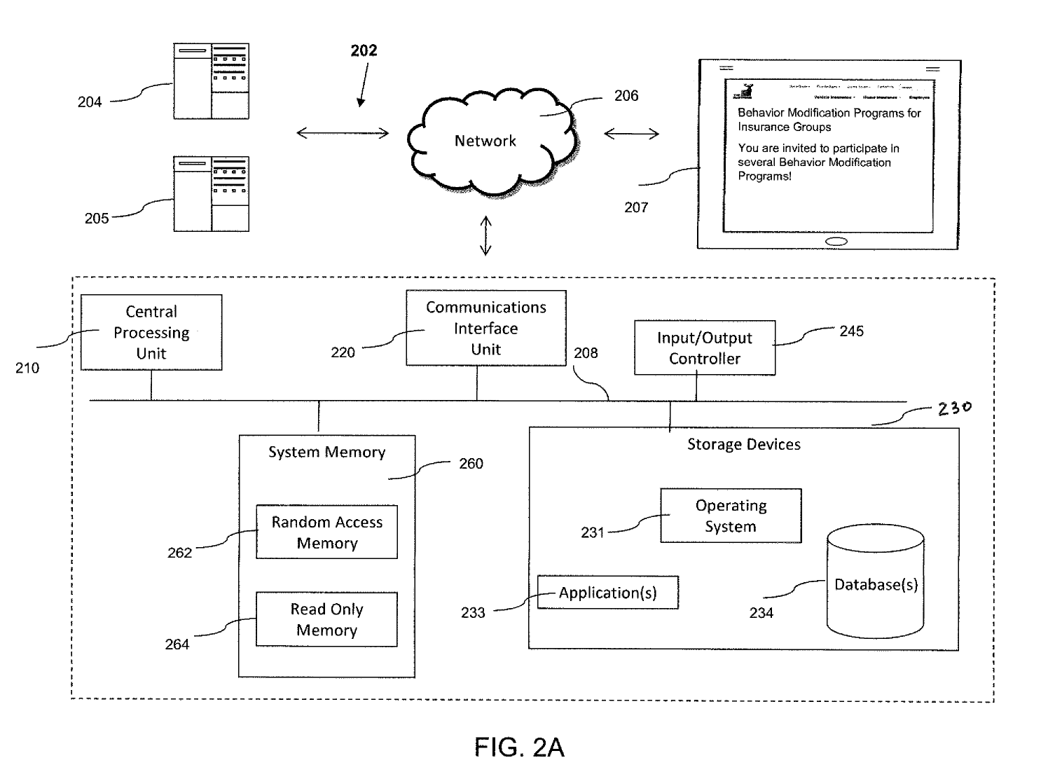

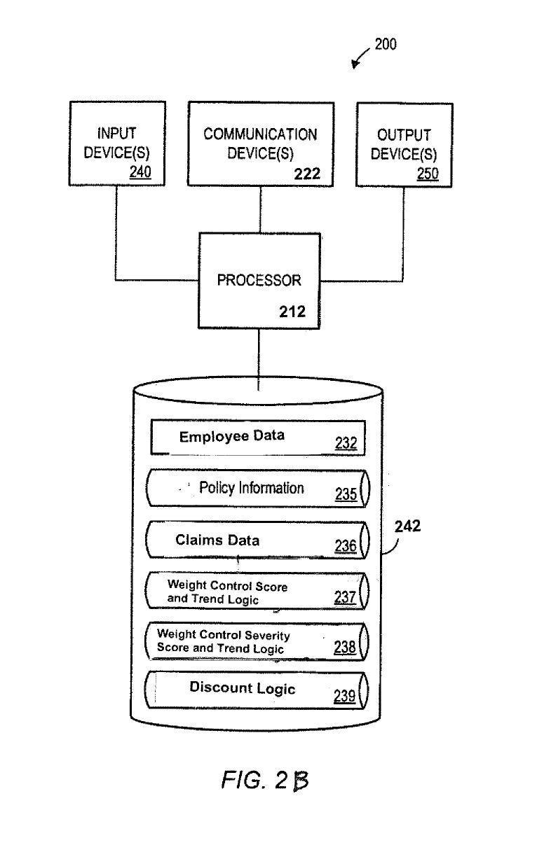

Referring to FIG. 2A, an exemplary computer system 202 for use in an illustrative embodiment of the invention will now be described. Computer system 202 may be configured to identify and select insurance groups and employees for participation in behavioral modification programs. System 202 may interface with another insurance company system 204 and a third party system 205 via a network 206. In an illustrative embodiment of the present invention, insurance company system 204 is responsible for workers compensation policy functions associated with customer and third party system 205 may be associated with providing and/or administering behavior modification programs identified and selected by the computer system 202. In computer system 202, a central processing unit or processor 210, which may include one or more processors, executes instructions contained in one or more programs such as insurance management application program 233, stored in one or more memories, such as storage devices 230. Processor 210 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 230 may include suitable media, such as optical or magnetic disks, fixed disks with magnetic storage (hard drives), tapes accessed by tape drives, and other storage media. Processor 210 communicates, such as through bus 208 and/or other data channels, with communications interface unit 220, storage devices 230, system memory 260, and input/output controller 245. System memory 260 may further include a random access memory 262 and a read only memory 264. Random access memory 262 may store instructions in the form of computer code provided by application 233 to implement embodiments of the present invention. System 202 further includes an input/output controller 245 that may communicate with processor 210 to receive data from user inputs such as pointing devices, touch screens, and audio inputs, and may provide data to outputs, such as data to video drivers for formatting on displays, and data to audio devices.

Storage devices 230 are configured to exchange data with processor 210, and may store programs containing processor-executable instructions, and values of variables for use by such programs. Processor 210 is configured to access data from storage devices 230, which may include connecting to storage devices 230 and obtaining data or reading data from the storage devices, or place data into the storage devices. Storage devices 230 may include local and network accessible mass storage devices. Storage devices 230 may include media for storing operating system 231 and mass storage devices such as storage 234 for storing data related to insurance information related to the customers such as employee information, claims history, etc. Communications interface unit 220 may communicate via network 206 with other financial services/insurance company computer systems such as insurance company system servers 204 as well as other servers, computer systems of agents, financial advisors, customers, remote sources of data, and with systems for implementing instructions output by processor 210. Insurance services company server 204 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP. Network 206 may be or include wired or wireless local area networks and wide area networks, and over communications between networks, including over the Internet. One or more public cloud, private cloud, hybrid cloud and cloud-like networks may also be implemented, for example, to handle and conduct processing of one or more transactions or calculations of embodiments of the present invention, including determination of behavior modification programs for groups and individuals. Cloud based computing may be used herein to handle any one or more of the application, storage and connectivity requirements of embodiments of the present invention. Furthermore, any suitable data and communication protocols may be employed to implement embodiments of the present invention.

With reference still to FIG. 2A, communications interface 220 is used for receiving user data related to the user's insurance requirement and background. Computer processor 210 executes program instructions, such as provided by the application 233 to receive, via the communications interface 220, third party data, program provider data, and insured company data and other related information. Database 234 may include transaction data such as historical data from the user or other third parties.

FIG. 2B is a block diagram of an exemplary computer system 200. Computer system 200 may represent an implementation of system 120 according to some embodiments. Computer system 200 includes computer processor 212 operatively coupled to one or more communication devices 222, data storage device 242, one or more input devices 240 and one or more output devices 250. Communication device(s) 222 may facilitate communication with one or more networks and/or external devices. Input device(s) 240 may comprise, for example, a keyboard, a keypad, a mouse or other pointing device, a microphone, knob or a switch, an infra-red (IR) port, a docking station, and/or a touch screen. Input device(s) 240 may be used, for example, to enter information into computer system 200. Output device(s) 250 may comprise, for example, a display (e.g., a display screen) a speaker, and/or a printer.

Data storage device 242 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

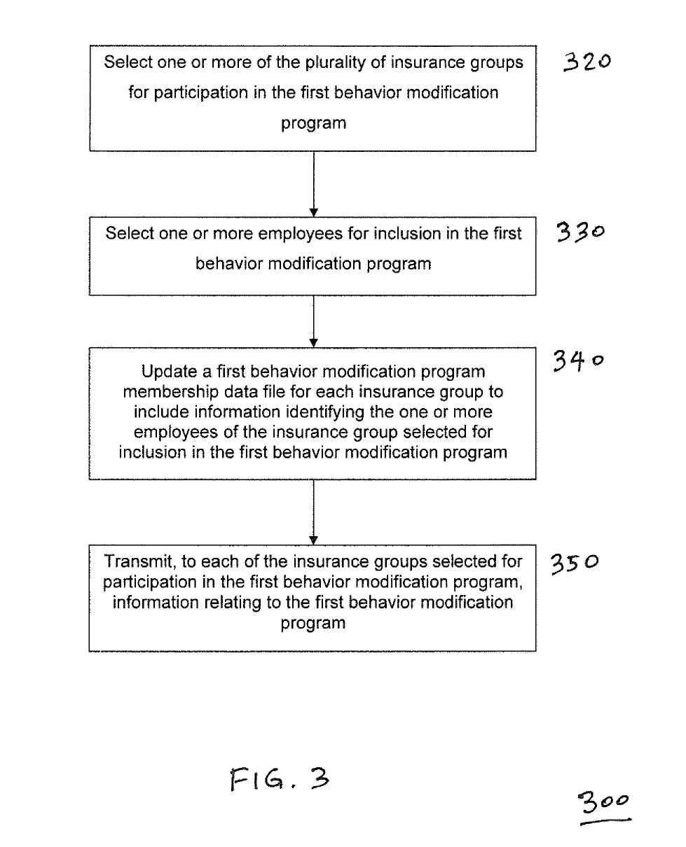

Data storage device 242 stores program instructions for execution by processor 212. In the embodiment of FIG. 2B, the behavior for which a score, severity score, and trends are determined is “weight control.” However, it is understood that the insurance computer may have program instructions relating to other types of behaviors such as, but not limited to, pain management behavior and employee safety behavior. In the embodiment shown in FIG. 2B, Weight Control Score and Trend logic 237, Weight Control Severity Score and Trend logic 238, and Discount logic 239 may comprise a set of such instructions, and may be executed by processor 212 to cause system 200 to operate as described herein with respect to FIGS. 3 through 6. Weight Control Score and Trend logic 237, Weight Control Severity Score and Trend logic 238, and Discount logic 239 may comprise any executable instructions, including but not limited to a database procedure, a database application, a server application and a desktop application.

Data storage device 242 stores data structures used during execution of Weight Control Severity Score and Trend logic 238, and Discount logic 239 according to some embodiments. These data structures will be described below as relational tables, but embodiments are not limited thereto. Moreover, the data structures need not be physically separated in memory as depicted herein.

Employee data 232 comprises information received from data sources 110 through 114 as described above and comprises information concerning employees covered by workers compensation or group benefits plans held by particular insurance group policy holders. Employee data 232 may include information such as, but not limited to, name, address, height, weight, job description, education level, geographic data, and age. Policy information 235 comprises information received from data sources 110 through 114 as described above. Policy information 235 may include, for a single group insurance policy, information received from more than one source, including information entered directly to system 200 via a terminal such as terminal 128. Claims data 232 comprises information received from data sources 110 through 114 as described above and comprises information concerning claims filed by employees covered by workers compensation or group benefits plans held by particular insurance group policy holders. Claims data 232 may include information such as, but not limited to, the medical condition covered by the claim, the cost of the claim, and the time period required for treatment of the medical condition covered by the claim. Claims data 232 may have historical workers compensation claims data and historical group benefit claims data for employee claimants of each of the plurality of insurance groups.

Data storage device 242 may store other data structures not shown on FIG. 2B that are used during execution of Weight Control Severity Score and Trend logic 238, and Discount logic 239 according to some embodiments. For example, a data structure may contain demographic data for insurance groups, which may be used during execution of the Weight Control Severity Score and Trend logic 238, and Discount logic 239. Alternatively, demographic data may be generated based on the policy information 235, employee data 232, and claims data 236. Data storage device 242 may also include a data structure for storing employer responses, for each of the plurality of insurance groups, to workers compensation and group benefits coverage inquiries. As disclosed in commonly-assigned application Ser. No. 13/839,098, filed on Mar. 15, 2013 and titled “System and Method for Workers' Compensation Related Risk Analysis,” specific questions may be formulated and asked that provide good predictive data for whether or not an insured or potential insured is likely to incur workers' compensation claims. Data storage device 242 may include a data structure for storing such responses.

The tables stored in data storage device may be updated via a network connection and/or via an attached terminal 128. Advantageously, the tables may provide a single repository for such data and behavior score, behavior score trend, and discount logic may automatically identify insurance groups and individual employees for participation and enrollment in behavior modification programs.

Computer systems 200 and 202 may include unshown elements for providing additional functionality and/or which are necessary for operation thereof, such as device drivers, operating system files, etc.

FIG. 3 is a flow diagram of process 300 according to some embodiments in which a behavior is selected for a behavior modification program and insurance groups and employees are selected for participation in the program. Various elements of system 120 or 122 and/or computer systems 200 or 202 may execute process 300 according to some embodiments. Process 300 may be embodied within program instructions of applications 233 of FIG. 2A of logic of FIG. 2B, but embodiments are not limited thereto. While FIG. 3 shows a process relating to selection of a single behavior, the process may be adapted to select two or more behaviors for which behavior modification programs may be made available to insurance groups and their employees. As will be understood, certain insurance groups may be more in need of certain behavior modification programs, depending on the nature of the work performed by the employees of the insurance group. For example, workers compensation or group benefits claims data might show that insurance groups in which the employees' jobs require physical labor may receive more claims for work-related injuries than insurance groups in which the employees have desk jobs. Furthermore, because physical injuries often coincide with pain, pain management behavioral programs may be more appropriately targeted to insurance groups covering employees who perform physical labor than to insurance groups covering employees who do not perform physical labor. By way of further example, workers compensation or group benefits claims data might show that insurance groups in which the employees have desk jobs receive more claims relating to weight or obesity issues than insurance groups in which the employees' jobs require physical labor. In this example, weight control behavior programs may be more appropriately targeted to the insurance groups having employees who have desk jobs than insurance groups in which the employees' jobs require physical labor. In an embodiment, multiple behavior programs may be made available to insurance groups, with the most applicable behavior program being offered first or, in embodiments, with a higher discount available, with secondary and tertiary behavior programs being offered for behavior programs that are less applicable to the insurance group than the first behavior program. Identifying particular insurance groups that might benefit from particular behavior modification programs helps the insurance group efficiently use its loss control dollars, and avoids unnecessary expenditure on broad, unfocused wellness programs that have questionable results.

Process 300 and all other processes mentioned herein may be embodied in processor-executable program instructions read from one or more non-transitory computer-readable media, such as a floppy disk, a CD-ROM, a DVD-ROM, a Zip™ disk, a flash drive, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

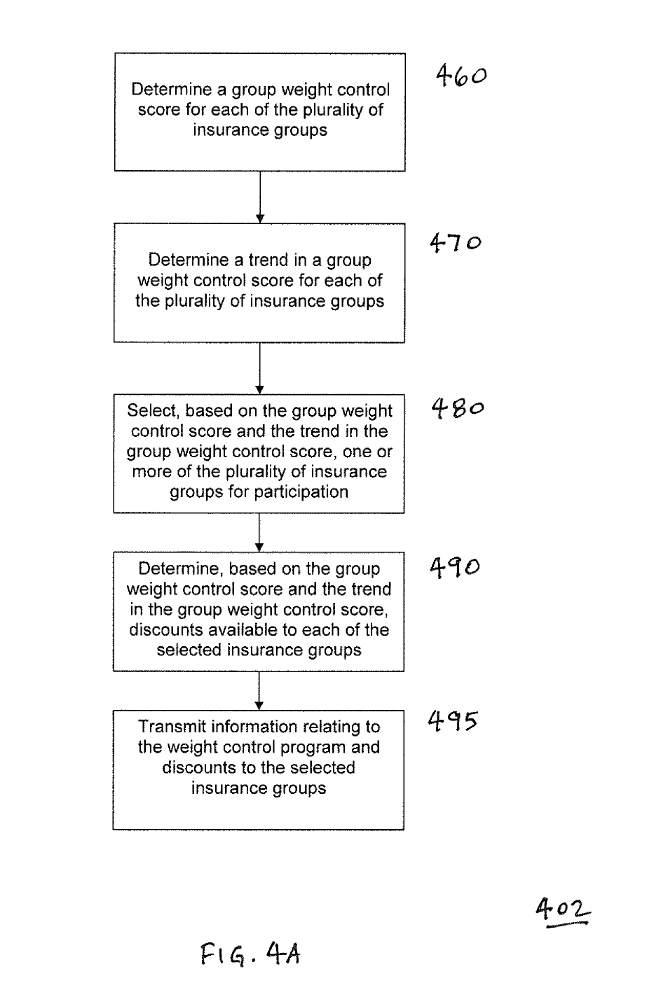

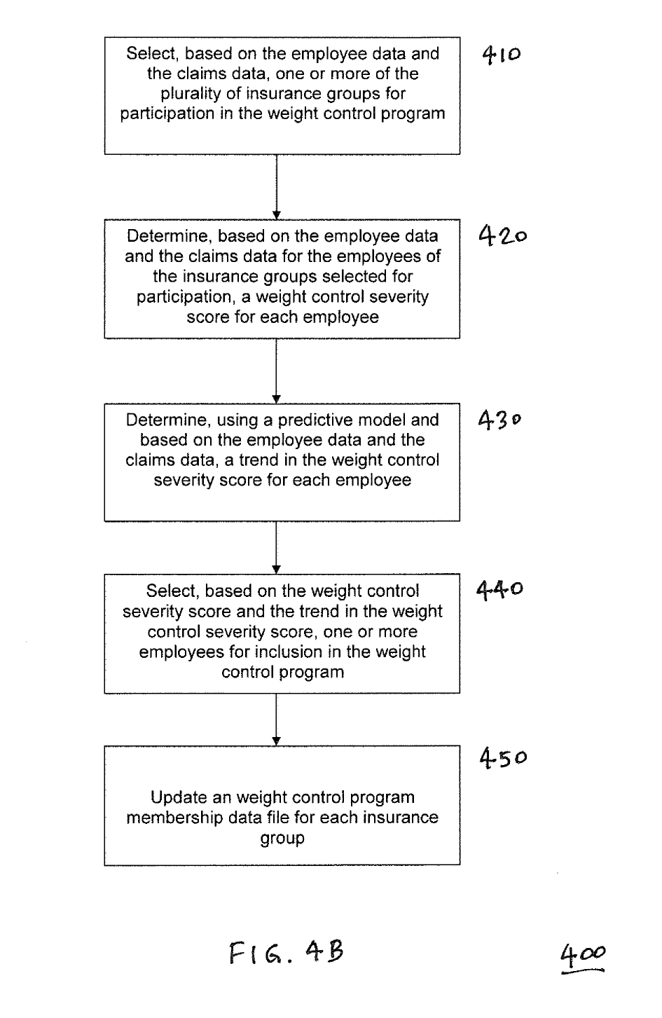

Initially at block 320, one or more of the plurality of insurance groups are selected for participation in the first behavior modification program. In an embodiment, the selected groups may be selected based on the employee data, the claims data, and/or the workers compensation class of the employees. For example, the claims data may be used to identify and select the insurance groups that are submitting a high severity or frequency of claims relating to the first behavior. In another embodiment, the workers compensation class may be used to select the groups for participation in the first behavior modification program. For example, insurance groups in the workers in the compensation classes that include manufacturing and construction may file more claims relating to injuries caused by improper safety. Accordingly, if the selected first behavior is safety behavior modification, the insurance groups in the workers compensation classes that included manufacturing and construction may be selected. In other embodiments, a score may be generated for each of the plurality of insurance groups, and selection of the groups for participation may be based on the score. Details regarding embodiments using a score to select groups for participation in a behavioral program are provided in relation to FIG. 4A.

The selection of the groups in relation to block 320 may also help determine which of the plurality of behaviors should be selected or used as the first behavior. For example, if calculations or analysis performed in relation to selecting groups indicates that some of the groups have a high frequency or severity of workers compensation or group benefits claims relating to a particular behavior, that behavior may be selected as a first behavior. In other embodiments, a system of an embodiment may be configured to select a behavior program for an insurance group having more than a threshold percentage of workers in a particular workers compensation class based on a stored correlation between the workers compensation class and a selected behavior or behavior program. Such a correlation may be determined based on analysis of claims history for workers compensation class. In further embodiments, analysis of groups may be performed for each behavior for which behavior programs are available to identify the behaviors that have a high frequency or severity of claims, and the first and subsequent behaviors may be selected based on the results of the analysis.

At block 330, one or more employees from the selected insurance groups are selected for inclusion or participation in the first behavior modification program. In an embodiment, the selected employees may be selected based on the employee data, the claims data, and/or the workers compensation class of the employees. For example, the claims data may be used to identify and select the employees that are submitting a high severity or frequency of claims relating to the first behavior. In another embodiment, the employee data, such as data relating to the employee's height and weight, may be used to select the employees for participation in the first behavior modification program. For example, employees whose height and weight indicate they are overweight or obese (compared to demographic height and weight data) may be selected for participation or inclusion in the behavior modification program. In other embodiments, a score may be generated for each employee of the selected plurality of insurance groups, and selection of the employee for participation may be based on the score. Details regarding embodiments that use a score to select employees for participation in a behavioral program are provided in relation to FIG. 4B.

FIG. 8 shows a database 800 which may be generated by the insurance system 120 or 122, which includes data fields that identify the specific programs that should be offered to specific employees in an insurance group. The data fields in the first column 810 of the database include the names of the employees of the insurance group, and in embodiments may include all of the employees of the group or may include the names of employees in particular workers compensation classes. The data fields in the second column 820 include the workers compensation class of each employee. In the example shown in FIG. 8, the workers are from a single insurance group but belong to two different workers compensation classes—4600 for employees working with computer chips and 8803 for employees who are computer system designers or programmers, who travel. The data fields in the third column 830 include data relating to which behavior program may be recommended as a first behavior program for a particular employee, while the data fields in the fourth column 840 and fifth column 850 include data relating to which behavior program may be recommended as second and third behavior programs for the employee.

In embodiments, the insurance computer 200 or 202 may be configured to prioritize all of the behavior programs it has available for each of the insurance groups, and/or it may configured to prioritize each of the programs for each of the employees of the insurance groups. For example, the insurance company may have four different programs available for insurance groups and employees to participate in. The insurance computer 200 or 202 may, in an embodiment, determine a priority for offering the programs to each insurance group. For example, if employee and claims data suggest or indicate that poor weight control is the primary driver for claims for an insurance group, the weight control program may be offered to the insurance group and specific employees may be identified for participation. Providing a single program to an insured company at a time, rather than providing multiple programs at the same time, may be more effective or easier to administer for the insurance company and program providers. After completion of the weight control program by the insurance group, the remaining programs available may be made available in their order of priority. In another embodiment, multiple programs may be made available to the insurance groups and employees at the same time, so that different employees at the same insurance group may be participating in different programs at the same time. In this embodiment, the programs may be prioritized based on the needs of each employee. For example, database FIG. 8 shows a database with data showing different programs prioritized by each employee separately, and in other embodiments a prioritization for all of the programs may be made for each of the employees.

In an embodiment, the fields selected for the database may be configured as needed according to whether the programs are offered serially (one at a time) or in parallel (all at the same time) to the insurance groups. In addition, the database shown in FIG. 8 merely shows one database that may be created from the data available to the insurance system 120 or 122. Other databases in the insurance system 120 or 122 may include employee and claims data, scores for insurance groups and employees, discounts available to insurance groups for completion of the program, and any other necessary data and fields for the processing of information as disclosed by embodiments of the invention.

In other embodiments, prioritization of additional behaviors and their related behavior modification programs may be based on scores calculated for each employee for each behavior. Scores for employees for particular behaviors may be determined as disclosed in relation to FIG. 4B. In another embodiment, the selection of a second behavior for provision of a second behavior modification program may be based on a known co-morbidity between the second select behavior and the first select behavior. For example, a first selected behavior program for an older employee may be a safety behavior program. Older employees are also more prone to weight issues; therefore a second behavior modification program that may be selected for the older employee may be a weight control behavior modification program.

At block 340, a first behavior modification program membership data file is updated for each insurance group to include the one or more employees of the one or more insurance groups selected for participation in the first behavior modification program. This file may be used by the insurance company, insurance group, and program administrator to arrange for participation in the program by the employee, and to provide access to the program to the employee. Last, at block 350, an insurance communications device such as communications interface 220 or 222 may be used to transmit, to each of the insurance groups selected for participation in the first behavior modification program, information relating to the first behavior modification program.

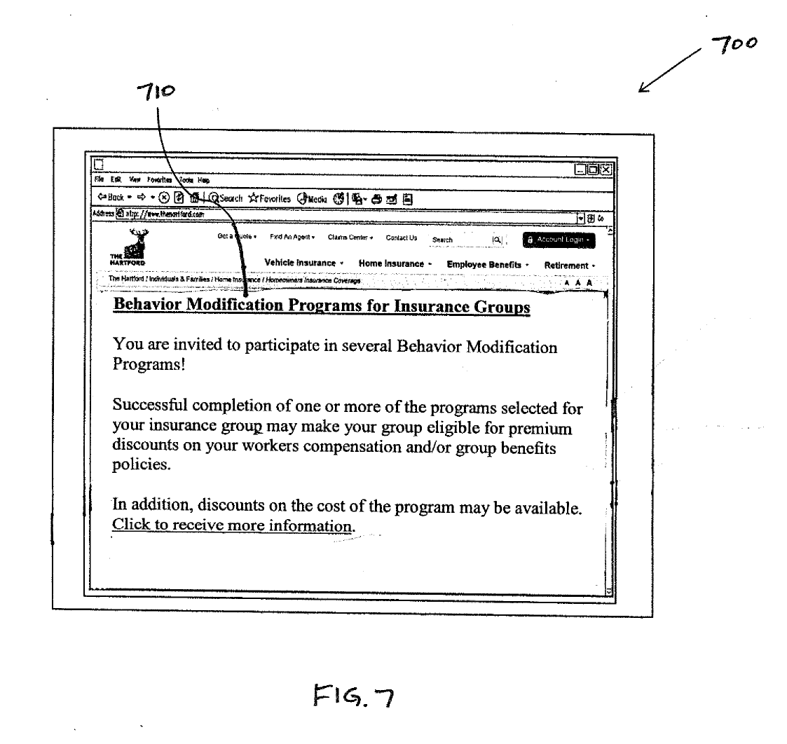

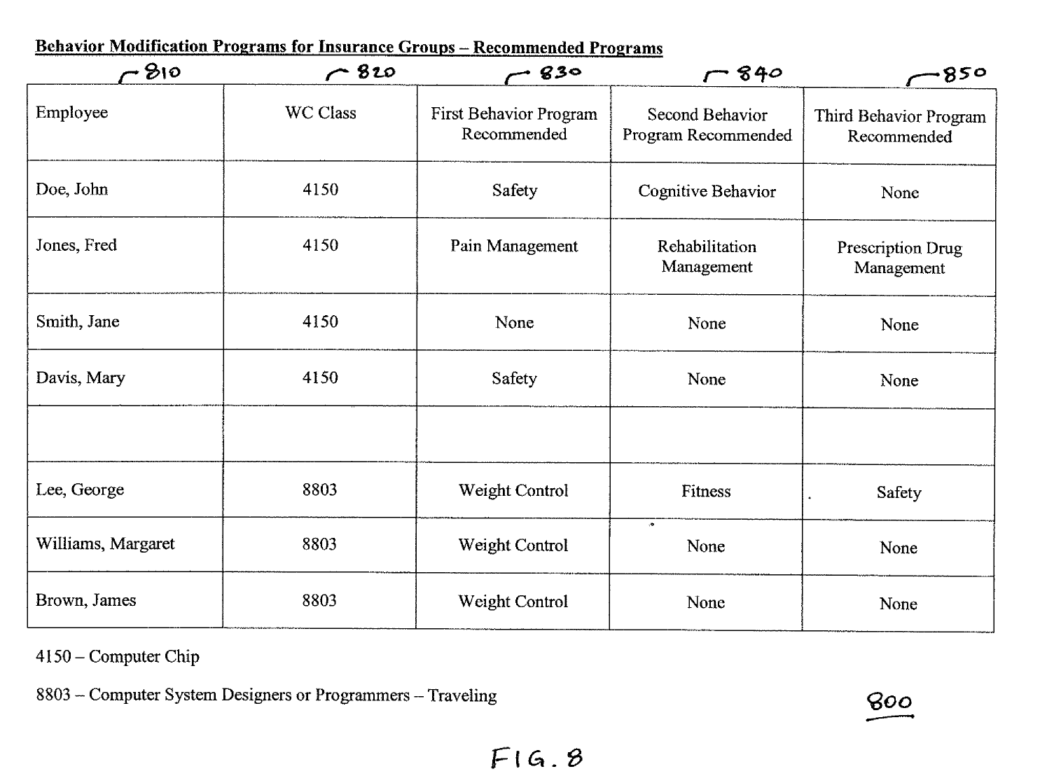

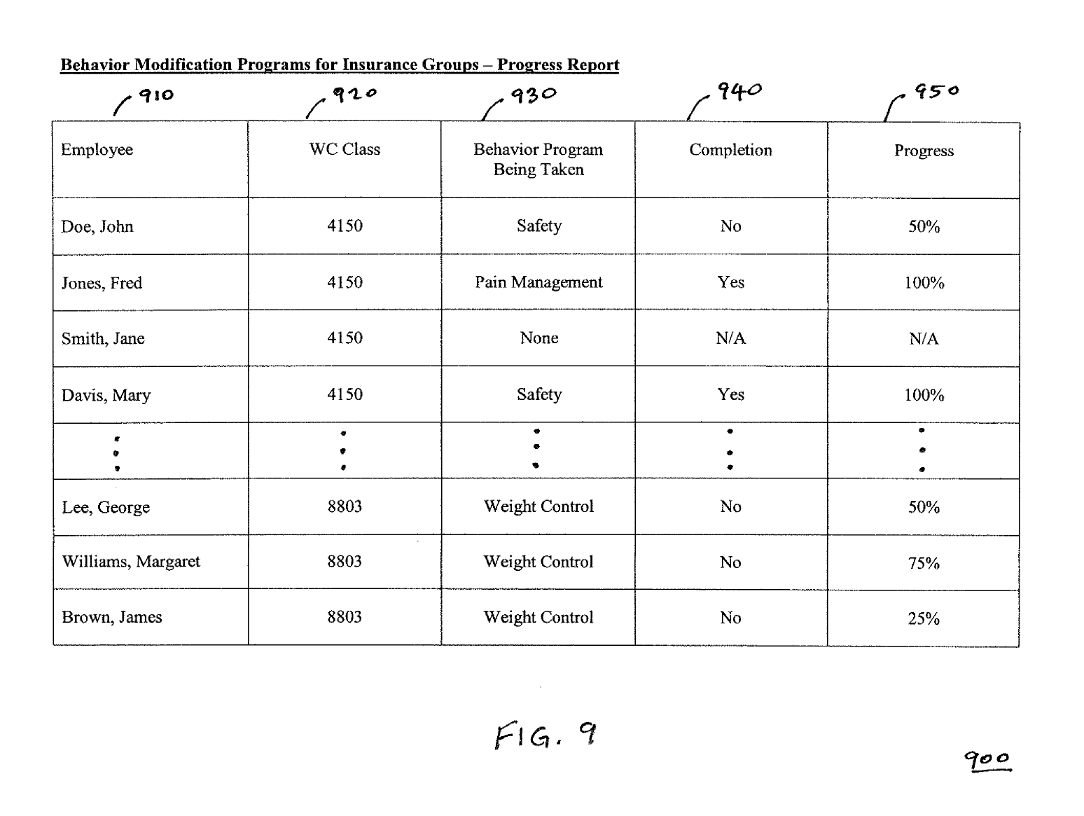

Insurance groups selected for participation in behavior management programs may receive information relating to the behavior programs by way of an invitation as shown in FIG. 7. FIG. 7 shows a screen 700 which may be transmitted and presented to an insurance group selected for participation in one or behavior programs. The screen 700 may include an invitation 710 to the insurance group to receive more information concerning available behavior modification programs. Additional screens (not shown) may follow the invitation screen and may set forth the particular programs being offered, the cost of the programs, the employees selected to participate, and any discounts available to the insurance group. In an embodiment, the information and invitation may be transmitted via an email to a person responsible for administering the insurance group at a business.

The insurance computer 120 or 122 may be configured with the applications 233 or logic to transmit a variety of different types of information to insurance groups or employees of the insurance groups who participate in the behavior modification programs. In particular, the participation of groups and employees in a selected behavior modification program may provide an opportunity to transmit targeted information to the employees that may aid in reducing the severity or frequency of behavior related claims. The information may include patient education materials and information concerning risk factors relating to the first behavior. This may help employees to identify a behavior related condition or identify an increasing severity of a condition relating to the behavior, and may provide information concerning ways to prevent the increasing severity of the condition. The information may include information concerning specific medical procedures or practices that are helpful for treating the first behavior, which may include procedures that have been identified by the insurance company as being particularly effective. In an embodiment, the information may also include information concerning specific medical professionals specializing in treating the first behavior, such as physicians or practices that are particularly experienced with performing particular procedures, which may increase the likelihood of a successful outcome over a procedure performed by a professional with little experience.

FIG. 4A is a flow diagram of process 402 according to some embodiments in which the behavior selected or identified to be addressed is weight control. Scoring and discounts relating to the other behavior modification programs behaviors may be determined similarly to the process shown in FIG. 4A in relation to weight control behavior. Various elements of systems 120 or 122 and/or computer systems 200 or 202 may execute process 402 according to some embodiments. Process 402 may be embodied within program instructions of weight control score and trend logic 237 or applications 233, but embodiments are not limited thereto. While FIG. 4A shows a process relating to a weight control program, the process may be adapted to be used with any of the plurality of behaviors identified as being behaviors for which a behavioral program can be made available to insurance groups for employees.

Initially, at block 460, a group weight control score is determined for each of a plurality of insurance groups that an insurance company wishes to review for possible participation in a weight control program. An insurance company may, in an embodiment, choose to review all of its insurance groups for participation in a weight control program, or may in an embodiment choose to review specific insurance groups based on a selected factor such as groups in a certain industry, groups in a certain region, etc. In an embodiment, the group weight control score for an insurance group may be determined based upon a comparison between the employee data and the claims data for the insurance group and demographic employee data and demographic claims data of insurance groups in the same industry and geographic region. By way of non-limiting example, a group weight control score may be determined for an insurance group based on the following:

$$GOS = \frac{{W}_{EEavg}}{{W}_{EEavgdemo}} \times \frac{{ClaimCost}_{avg}}{{ClaimCost}_{avgdemo}} \qquad ( 1 )$$

In Equation (1), GOS is the group weight control score. W_{EEavg} is the average weight of the employees in the insurance group. W_{EEavgdemo} is the average weight of employees in the demographic. ClaimCost_{avg} is the average cost per workers compensation claim of claims of the insurance group. ClaimCost_{avgdemo} is the average cost per workers compensation claim of claims of the demographic. It will be appreciated that the simple ratios of Equation (1) may be modified by one or more weighting factors. It will be appreciated that employee average weight is only one factor that may be used. For example, the insurance company may have actual weight control rate data, or may have both weight and height data for employees, from which weight control rates may be determined. Other and additional factors related to claims, such as rates of claim incidence (per employee per time period), rates of claims of types linked to weight control, such as back and knee injuries, and other factors.

In an alternative embodiment, the group weight control score may be determined based on the workers compensation experience modifier for an insurance group or company. A group weight control score can also be based on both a comparison between employee and claims data of an insurance group and demographic employee and claims data, and also the workers compensation experience modifier for an insurance group or company. In an embodiment, a higher weight control score may be indicative of a higher rate of weight control in an insurance group than a lower weight control score. The group weight control score may take the form of a raw score (e.g., 1-10), a probability value in the form of a probability, i.e., a numeric value between zero and one or between zero percent and one hundred percent, a tier or classification value (e.g. high level of weight control, medium level of weight control, or low level of weight control or level 1, level 2, level 3, level 4, or level 5).

At block 470, a trend in a group weight control score is determined for each of the plurality of insurance groups. A trend in the group weight control score can be determined by calculating and determining historical or future weight control scores for an insurance group for a specified period of time. For example, in an embodiment, a yearly weight control score for each of the past 5 years could be calculated and compared for an insurance group to identify a trend in the group weight control score for the company, such as whether the score has been increasing, decreasing, fluctuating, or remained flat over the specified time period. As will be understood, information about a trend in a group weight control score may help an insurance company to better select insurance groups for participation in a weight control program. For example, if two insurance groups have the same weight control score, but the first group has an upward trend in its score and the second group has a downward trend in its score, it may be preferable to offer the first group participation in the weight control program.

In an embodiment, weight control score and trend logic 237 or applications 233 may include logic for determining a future weight control score and future trend in a group weight control score for insurance groups, for a specified period of time. For example, weight control score and trend logic 237 or applications 233 may include predictive modeling logic to predict future weight control scores for insurance groups for a specified period of time such as 5 years. For example, a predictive model may be trained with historical employee and claim data, and applied to received employee and claim data to determine a predicted group weight control score. A predictive model may identify “predictive characteristics” of the employee and claim information (e.g., weight, job description, geographic region, treatment for weight control-related conditions, etc.) which exhibit a significant correlation with weight control. Accordingly, the predictive characteristics of employee and claim information may be analyzed by the predictive model to determine future group weight control scores. The predictive characteristics may include, but are not limited to, employee job descriptions, employee age, employee weight, employee height, and employee geographic data, historical workers compensation claims data, and historical group benefit claims data for employee claimants of each of the plurality of insurance groups.

With these parameters, the computer systems 100 or 102 determine the predicted group weight control score by using a predictive model. The predictive model may be formed from neural networks, linear regressions, Bayesian networks, Hidden Markov models, or decision trees. The predictive model(s) may be formed, at least in part, using various techniques described in commonly-assigned U.S. patent application Ser. No. 11/890,831, filed Aug. 7, 2007, the entirety of which is hereby incorporated by reference.

In one particular embodiment, the computer systems 100 or 102 use a linear predictive model based on logistic regression. In another embodiment, the computer systems 100 or 102 use a predictive model based on hierarchical regression tree techniques, such as a classification and regression tree (CART) model. In this embodiment, the computer systems 100 or 102 use all potential variables that could contribute to weight control to construct the predictive model. The predictive model thus created predicts the group weight control score. In other embodiments, the computer systems 100 or 102 may determine weights for each potential variable, and then either incorporate each of the potential variables into the predictive model according to its weight, or select a subset of the variables to incorporate into the model, such as, for example, the ten variables with the largest weights.

In some embodiments, the computer systems 100 or 102 generate both a linear predictive model and a hierarchical regression tree predictive model with similar sets of input parameters. The computer systems 100 or 102 then select the particular model by subjecting the models to model validation tests against one or more sets of historical data. These tests include a minimum mean square error test, in which the total mean square error of all of the parameters in a model are calculated with respect to a set of historical data and then compared to either the total mean square error of another model or to a threshold; a receiver operating characteristic (ROC) test, which determines a ratio of false positives to false negatives for each model with respect to the historical dataset(s); and/or a cross validation test, which compares model performance on a portion of historical data not used in the model determination process. However, in other embodiments, other suitable model validation tests or combinations thereof may be used to select the predictive model.

In other embodiments, a group weight control score may be developed using manually inserted variables and factors. Examples of variables include geography and socioeconomic status. For example, adult obesity rates varied by state between 20.5% (Colorado) and 34.7% (Louisiana) in 2012. An algorithm may be developed in which a state of employee residence is mapped to a value that is proportional to the adult obesity rate in the state (or other geographic region) of residence. Similarly, socioeconomic status may be mapped

At block 480, one or more of the plurality of insurance groups are selected for participation in the weight control program. As will be understood, a number of different methods may be used to select groups for participation. For example, groups may be selected that have a group weight control score (or in an embodiment a future weight control score) that is higher than a threshold weight control score that is known to be associated with insurance groups who have a higher number of workers compensation and/or group benefits claims. In another embodiment, groups may be selected based on a trend in the group weight control score, such as if a rate of increase of the group weight control score is higher than a threshold rate. By way of further example, both the group weight control score and the trend in the score may be used to make the determination of which groups are selected for participation in the weight control program. As noted in an earlier example, if two insurance groups have the same weight control score, but the first group has an upward trend in its score and the second group has a downward trend in its score, it may be preferable to offer the first group participation in the weight control program.

At block 490, discounts may be determined for the insurance groups selected for participation in the weight control program. In an embodiment, it may be advantageous to an insurance company to offer higher discounts to insurance groups with one or more of higher weight control scores, higher predicted group weight control scores, or a higher rate in increase in weight control scores, as it is known that such insurance groups experience a higher number and severity of workers compensation and group benefits claims. The offer of a greater discount may make it more likely that the insurance group will participate in the program, which may help the insurance company avoid excessive claims in the future. Therefore, in an embodiment, a sliding scale of discounts may be offered, with insurance groups having lower weight control scores and/or an acceptable change in rate (e.g. a stable score) of their weight control scores may be offered lower discounts than insurance groups with higher weight control scores and/or higher rate of change in weight control score indicative of an increasing number of obese workers at the insurance group. In other embodiments, a single discount may be offered to most insurance groups, with only the insurance groups with the highest weight control scores or trends receiving large discounts.

In an alternative embodiment, an insurance company may propose a cost sharing arrangement for participation in the program. The administrator of the program may charge a per-seat fee based on the actual number of employees that participate in the program. The insurance company may propose creative arrangements with the insurance group to encourage participation in the program. For example, the insurance company may offer to fully pay for the program for employees with the highest weight control scores, or the insurance company may offer discounts based on the percentage of the employees in an insurance group with the high weight control scores that enroll in the program. Offering the program to insurance groups on a per-seat, selective enrollment, basis rather than to all of the employees of an insurance group may provide substantial cost savings to the insurer and the insurance group, which is unique to the weight control program. Typically, wellness programs are offered to all employees of an insurance group, which greatly increases the financial investment required by an insurance group to offer the program. In addition, because wellness programs target issues other than weight control such as smoking, they are inherently more expensive on a per-seat basis than programs that only target weight control or other individual behaviors.

At block 495, information relating to the weight control program and a discount available (or other cost sharing proposals) may be transmitted to the insurance groups selected for participation in the weight control program.

FIG. 4B is a flow diagram of process 400 according to an embodiment in which the selected behavior is weight control, although the process may be applied to other types of behaviors. Various elements of systems 120 or 122 and/or computer systems 200 and 202 may execute process 402 according to some embodiments. Process 400 may be embodied within program instructions of weight control severity score and trend logic 238 or applications 233, but embodiments are not limited thereto.

Initially, at block 410, one or more of a plurality of insurance groups are selected for participation in a weight control program. As detailed in relation to FIG. 4A, selection of groups may be based on one or more of a group weight control score, a predicted group weight control score, or a trend in a group weight control score. Selection of groups for participation in the weight control program may, in an embodiment, be based on the workers' compensation experience modifier. Other methods used to select one or more insurance groups for participation in the weight control program will also work with the process shown in FIG. 4B.

At block 420, a weight control severity score is determined for each employee of the groups selected for participation in the weight control program. As will be understood, within an insurance group, there may be employees who are obese but there will also be employees who are not obese. Determining a weight control severity score for each employee of a selected insurance group allows the insurance company to identify the individuals most in need of a weight control program. In an embodiment, the weight control severity score for an individual may be based on a comparison of an attribute of the employee to a threshold value for that attribute. For example, the weight control severity score may have a value between 1 and 10, with 1 being not obese and 10 being obese. An attribute for weight may have a threshold value of 300 pounds, and any employees over 300 pounds may be deemed to have a weight control severity score of 10 based on the single attribute. In another embodiment, more than one attribute and associated threshold value may be used to determine a weight control severity score. In a further embodiment, the weight control severity score may be based on a comparison of employee attributes to average demographic attributes. For example, employee data such as height and weight may be compared to height and weight of employees working for insurance groups in the same industry and geographic region to determine a weight control severity score. As noted in relation to FIG. 4A, employee data may include one or more of employee job descriptions, employee age, employee weight, employee height, employee geographic data, employee claims, and employee demographic data. The weight control severity score may be based on different scales, such as 1-10 or 1-100, or on different values—low, medium, high—or any other scale.

In yet a further embodiment, the insurance company may determine that the chances of receiving a positive response from an employee to an offer for a weight control program may be higher if all of the employees of the insurance group are offered enrollment in the program, rather than just selected employees. In this embodiment, the weight control severity score may be set at a level (e.g., 10) for all of the employees so that all of the employees will receive an offer to enroll in the program, with the anticipation that not all of the employees will actually participate.

A weight control severity score for an employee may also be based on claims data for the employee. Claims data will typically include information such as the medical condition for which the claim was filed. Certain medical conditions which are associated with weight control or which may be weight control-related may provide a basis for setting or adjusting (up or down) a weight control severity score. The number of claims filed for an employee over a predetermined time period may also provided a basis for setting or adjusting a weight control severity score. For example, the filing or multiple claims for an employee for relating to diabetes, or joint or back problems may be an indicator of a weight control issue, and may provide a basis for setting or adjusting a weight control severity score. The number of sick days taken by an employee may also provide a basis for setting or adjusting a weight control severity score, alone or in combination with other factors. In other embodiments, other data that may be used to determine a weight control severity score (or other score for other behaviors) for an individual employee may include a number and value of workers compensation or group benefit claims made by the employee within a selected time period; a volatility of workers compensation or group benefit claims made by the employee within a selected time period; a severity of workers compensation or group benefit claims made by the employee within a selected time period; and a disease loading factor applicable to workers compensation or group benefit claims made by the employee within a selected time period.

At block 430, a trend in a weight control severity score is determined for each of the employees, or in an alternative embodiment, for the employees having a weight control severity score above a threshold value. A trend in the weight control severity score can be determined by calculating and determining historical or future weight control severity scores for each employee for a specified period of time. For example, in an embodiment, a yearly weight control severity score for each of the past 5 years could be calculated and compared for an employee to identify a trend, such as whether the employee's score has been increasing, decreasing, fluctuating, or remained flat over the specified time period. As will be understood, information about a trend in a weight control severity score may help an insurance company to better select employees for participation in a weight control program. For example, if two employees have the same weight control severity score, but the first employee has an upward trend in his or her score and the second employee has a downward trend in his or her score, it may be preferable to offer the first employee participation in the weight control program.

In an embodiment, weight control severity score and trend logic 238 may include logic for determining a future weight control severity score and future trend in a weight control severity score for employees, for a specified period of time. For example, weight control severity score and trend logic 237 may include predictive modeling logic to predict future weight control severity scores for employees for a specified period of time such as 5 years. The predictive modeling may be similar to the modeling described herein in relation to block 470 of FIG. 4A.

At block 440, individual employees of a participating insurance group are selected for participation or enrollment in the weight control program. As will be understood, a number of different methods or processes may be used to select employees for participation. For example, employees may be selected that have a weight control severity score (or in an embodiment a future weight control severity score) that is higher than a threshold weight control severity score. The threshold weight control severity score may be determined manually or by calculation to determine a weight control severity score correlated with employees who have a higher rate or cost of workers compensation and/or group benefits claims. In another embodiment, employees may be selected based on a trend in the weight control severity score, such as if a rate of increase of the weight control severity score is higher than a threshold rate. By way of further example, both the weight control severity score and the trend in the severity score may be used to make the determination of which employees are selected for participation in the weight control program. As noted in an earlier example, if two employees have the same weight control severity score, but the first employee has an upward trend in his or her severity score and the second employee has a downward trend in his or her severity score, it may be preferable to offer the first employee participation in the weight control program. In embodiments, a combined score based on factors including at least a weighted weight control severity score and a weighted trend rate may be determined and compared to a threshold. In embodiments, a number of employees to be invited to a weight control program may be determined, such as manually, and the employees having the highest weight control severity scores, or other scores, may be invited up to the determined number.

At block 450, a weight control program membership data file is updated to include information identifying the one or more employees of the insurance group who were identified for participation in the weight control program. The weight control program membership data file may reside on system 120 or 122, or in an embodiment may also or alternately reside on administration system 130 or 134.

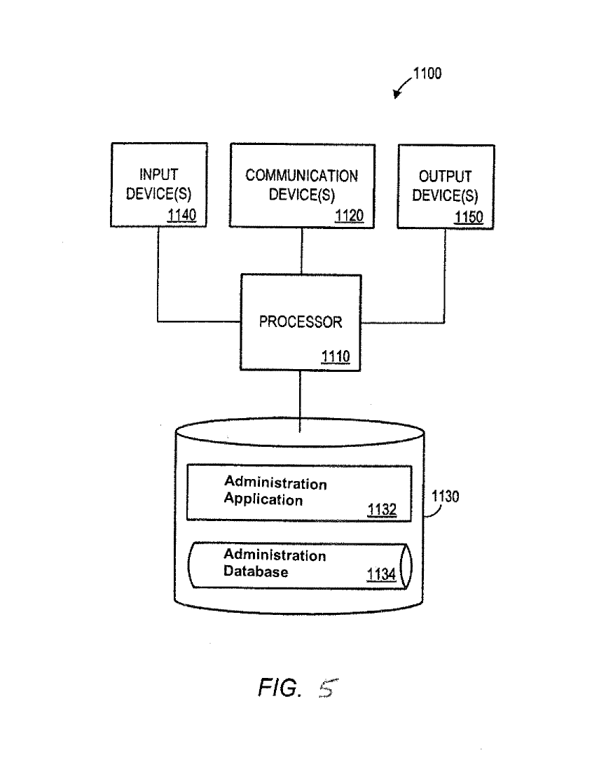

FIG. 5 is a block diagram of computer system 1100 according to some embodiments. Computer system 1100 may perform the functions of an administrator of the weight control program. An administrator of the weight control program makes the program available to employees who wish to participate in the program. In an embodiment, the program has a fixed duration or fixed number of sessions for the employee, although in other embodiments, the program may be more open-ended and based on weight loss goals of the employee. In an embodiment, administration of the weight control program may be handled by an insurance company. In another embodiment, administration of the weight control program may be performed by an outside or third party provider of weight control programs, such as Weight Watchers, Jenny Craig, and other known weight loss services. Alternatively, a group within the insurance company may handle administration of a third party weight control program. The elements of administration system 1100 may be implemented using any of the alternatives described above with respect to similarly-named and numbered elements of computer system 200, but embodiments are not limited thereto.

Computer system 1100 may receive data from components shown in FIGS. 1A and 1B, such as insurance systems 120 and 122, insurance group computers 157A, and 157B, or employee devices 140, 145, and 150. Data received records from of the various feeds generated according to the process of FIGS. 3 through 6. The records may be received via one or more of communication device(s) 1120 and each record may be associated with an employee of an insurance group. The records are stored in administration database 1134 of data storage device 1134. Administration database 1134 may include records associated with administration of the weight control program such as a weight control program membership data file, usage data for employees participating in the program, and health data received from employees participating in the weight control program. Administration application 1132 includes executable program instructions to provide administrative functions based on the records of database 1134. For example, administration application 1132 may include program instructions for providing access to the program to employees via the world wide web, for tracking usage of the program by employees via the world wide web, and for sending usage data to insurance systems 120 or 122. Administration application 1132 may also include program instruction for receiving and/or requesting health data from employees.

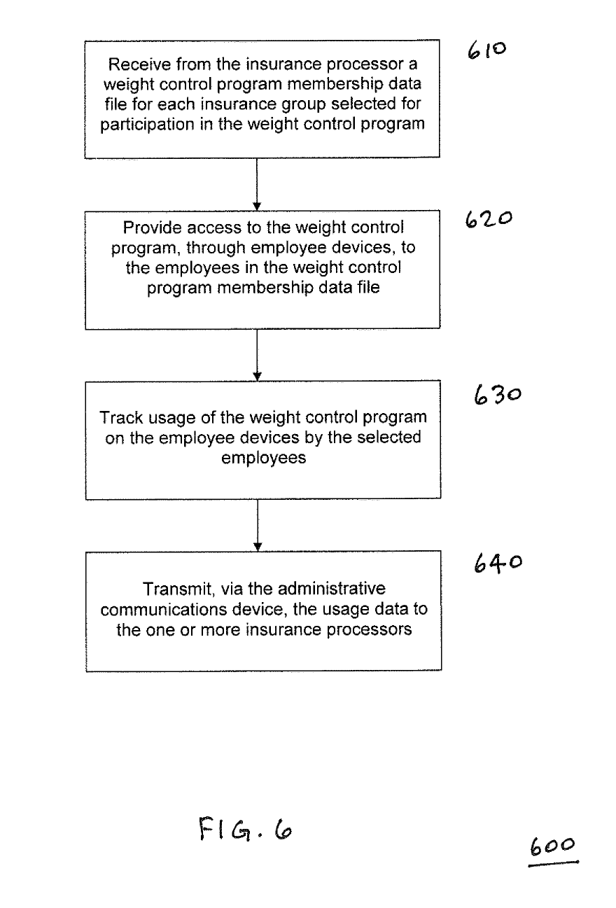

FIG. 6 is a flow diagram of process 600 according to some embodiments. While FIG. 6 shows an embodiment in which the behavior being addressed is obesity or weight control, the process may be applied to other behaviors and behavior programs. Various elements of administration systems such as systems 130 or 134 may execute process 600 according to some embodiments. Process 400 may be embodied within program instructions of administration application 1132, but embodiments are not limited thereto.

Initially, at block 610, administrative systems 130 or 134 receive from the insurance processor a weight control program membership data file for each insurance group selected for participation in the weight control program. The data file contains information concerning the employees identified for inclusion and participation in the program such as the employee names. As will be understood, this information can then be used by the administrative system to set up accounts or other means for the employees to access the materials for the program via the world wide web or internet. In block 620, access to the weight control program is provided to the participating employees based on the membership data file. In an embodiment, the administrative application 1132 has program instructions for setting up access by the employees once the membership data file is received from the insurance systems 120 or 122. In another embodiment, an administrator may use input device 1140 and output device 1150 of the administration system 1100 to set up access for the employees.

At block 630, usage of the program by the employees is tracked. As noted, employees may access the program through their own devices such as computers, laptops, tablets, and smart phones, or they may access the program on computers at their place of employment such as computers 157A and 157B. All of those uses may be tracked by administrative systems 130 or 134, which has program instructions in administrative application 1132 for tracking usage.

At block 640, the usage data is transmitted via the administration communication device 1120 to the processors of the insurance systems 120 or 122. Insurance systems 120 or 122 may then process the usage data to determine a usage rate for each employee in the program, which may allow the insurance systems 120 or 122 to identify suboptimal participation by employees. The insurance systems 120 or 122 may include program instructions for determining other metrics using the usage data, such as an enrollment rate, and attrition rate, and a completion rate for the program. In another embodiment, the administration systems 130 or 134 may also transmit health data to the insurance systems 120 or 122. The health data may include information input by an employee user into an interface provided by the weight control program that may request information such as weight obtained in weekly weigh-ins, calories consumed by a user, exercise performed by the employee, blood pressure information, and other health information. The health data may also include human telematics data that may be obtained from an employee, such as movement data from a device (e.g., the FITBIT™ brand motion sensing device) having one or more motion sensors and associated processing and memory devices to record individual motion data and make that data accessible to, or transmit such data to, other devices, with a motion sensor, pedometer data relating to a number of steps taken by an employee, and any other human telematics data. Data may be acquired from exercise facilities, fitness instructors, corporate dining facilities or other cooperating restaurants or dining facilities and other data sources regarding exercise engaged in, fitness classes, food items purchased, and transmitted to one or both of insurance system and administration systems 130 or 134. The insurance systems 120 or 122 may include program instructions for determining, based on the health data, an effectiveness score for the weight control program. The effectiveness score can be on an employee basis or on an insurance group basis. In an embodiment, the insurance system may include program instructions for communicating with an insurance group that has a low effectiveness score, to inform the group of potential issues. In another embodiment, the insurance systems 120 or 122 may include program instructions for determining additional discounts for an insurance group that has a high effectiveness score. The insurance systems 120 or 122 may include program instructions for determining other metrics using the health data, such as aggregate weight loss for each employee or for each insurance group.

FIG. 9 shows a progress report 900 that may be generated by the administrative systems 130 or 134 to track the progress of employees taking behavior modification programs. In an embodiment, column 910 includes the names of the employees taking behavior modification, column 920 includes the workers compensation class of the employees, and column 930 includes the behavior program being taken by the employee. Column 930 includes an indication of whether the behavior modification program has been completed by the employees, which information may be provided to the insurance company, insurance group, or program provider so that employees who have not completed the program can be prompted to do so. Column 940 indicates the employee's progress in the program, which may help identify employees with little progress who may require additional prompting to complete the program.

The insurance systems 120 or 122 may also determine an effectiveness score for the weight control program based on data other than health data received from the administration computers 130 or 134. For example, in an embodiment, the insurance system may have program instructions for receiving, via the insurance communications device, additional employee data and additional claims data for a time period after completion of the weight control program by an insurance group. The insurance system may also have program instructions to determine a weight control program effectiveness score based on the additional employee data and additional claims data. For example, the additional employee data may have weight data to compare to previous weight data for the employees, from which an effectiveness score for the program may be determined. In another example, the claims data may reflect a reduction in the number of claims filed by employees who participated in the program, from which the effectiveness score of the program may be determined. By way of further example, the insurance system may include program instructions to receive workers compensation experience modifier data for a time period after completion of the weight control program by an insurance group, and program instructions to determine, based on the workers compensation experience modifier data, the weight control program effectiveness score for one or both of an employee enrolled in the weight control program and an insurance group that participated in the weight control program.

Although in the embodiment herein a group weight control score is used to select insurance groups for participation in the weight control program, and then individual employees of the participating groups are identified for inclusion in the program, other methods and processes may be used. For example, in an embodiment, individual weight control scores for each employee of the insurance groups may first be determined, and then from those scores, a determination may be made which insurance groups to select for participation. Furthermore, although in the embodiment herein group and individual weight control scores and trends are determined, the processes described herein can be used to determine scores for any other of the behaviors. For example, group and individual pain management scores and trends may be determined using similar processes to those described, and group and prescription drug management scores may be determined using similar processes to those described.

In embodiments, an insurance company system may calculate weight control severity scores and trends on an individual basis for claimants under workers compensation policies, group benefits policies, and other insurance policies. The calculated scores may be compared to one or more thresholds. Responsive to determining that a determined weight control severity score, weight control severity score trend, or combined score, for a claimant, exceeds a threshold, the system may provide a determination that a weight control program is to be offered to the claimant at no cost to the claimant or to the policyholder. The insurance system may be configured to communicate offer and enrollment information to the claimant, such as by sending an e-mail, postal mail, text message or other message requesting the claimant to access a web address to enroll in a weight control program. In embodiments, the system may be configured to determine weight control severity scores and trends for claimants only responsive to data indicative of an injury to a selected body part, e.g., back or knee. The selected body part may be correlated with weight control-related injury risk. In embodiments, injuries or body parts may be selected based on correlation between the injury type or body part and a higher than typical risk of a high cost claim or a claim that takes a longer than typical period for resolution. Correlations may be determined using predictive models, by way of example.

Data storage in connection with one or more embodiments described herein may be spread across one or more computer-readable storage media, and may be or include one or more relational databases, hierarchical databases, object-oriented databases, one or more flat files, one or more spreadsheets, and/or one or more structured files. Databases may be managed by one or more database management systems, which may be based on a technology such as Microsoft SQL Server, MySQL, Oracle Relational Database Management System (RDBMS), PostgreSQL, a NoSQL database technology, and/or any other appropriate technology.

User interaction with one or more computer systems described herein may be mediated via one or more web site systems. The web site systems may generate one or more web pages for access by user devices 140, 150, 157A and 157B, by way of example, and may receive responsive information from user devices such as employee health information, weight control program enrollment and participation data and other data. The web site systems may then communicate this information to other systems described herein such as systems 200, 202, and 1100 for processing via communications devices 220, 222, and 1120.

The web site systems may include web application modules and HyperText Transfer Protocol (HTTP) server modules. The web application modules may generate the web pages that make up the web sites for presentation to employees, claimants, employer representatives, insurance company representatives, third party weight control program provider representatives, and others, and that are communicated by the HTTP server modules. Web application modules may be implemented in and/or based on a technology such as Active Server Pages (ASP), PHP: Hypertext Preprocessor (PHP), Python/Zope, Ruby, any server-side scripting language, and/or any other appropriate technology.

HTTP server modules may implement the HTTP protocol, and may communicate HyperText Markup Language (HTML) pages and related data from the web site to/from computer systems such as systems 200, 202, and 1100 and/or client devices using HTTP. HTTP server modules may be, for example, Sun-ONE Web Servers, Apache HTTP servers, Microsoft Internet Information Services (IIS) servers, and/or may be based on any other appropriate HTTP server technology. Web site systems may also include one or more additional components or modules, such as one or more switches, load balancers, firewall devices, routers, and devices that handle power backup and data redundancy.

User devices such as devices 140, 144, 150, 157A and 157B may include a web browser modules, which may communicate data related to the web site to/from HTTP server modules and the web application modules of web site systems. Such a web browser module may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module may implement Rich Internet Application (RIA) and/or multimedia technologies such as Adobe Flash, Microsoft Silverlight, and/or other technologies. The web browser module may implement RIA and/or multimedia technologies using one or web browser plug-in modules (such as, for example, an Adobe Flash or Microsoft Silverlight plugin), and/or using one or more sub-modules within the web browser module itself. The web browser modules may display data on one or more displays that are included in or connected to the user device such as a liquid crystal display (LCD) display, organic light-emitting diode (OLED) display, touch screen or monitor. The user devices may receive input from the user of the user device from input devices that are included in or connected to the user device, such a mouse or other pointing device, or a touch screen, and provide data that indicates the input to the web browser module.

User devices may download, store and execute special-purpose application programs, or apps, to implement one or more of the steps and methods described herein. By way of example, smartphones for use by employee and claimant participants may access, download, configure, store and execute one or more apps for communicating with an administrator system to be prompted to fulfill obligations of the weight control program, provide health data, and take other steps related to weight control programs. Smartphones for use by employer representatives may access, download, configure, store and execute one or more apps for receiving administrator data regarding participation. Apps for use by employer representatives may include processing and display capability to determine and/or display projections of insurance premium discounts based on current employee health data, and be configured to provide alerts to employer representatives of projected loss of insurance discounts or other negative insurance events.

In embodiments, insurance systems may make determinations relating to insurance policies other than premium and discount determinations based on employee health data, participation in weight control program data and the like. For example, other terms of insurance policies may be adjusted, such as deductibles, coverage limits and other terms.

In embodiments, methods and systems identified herein may be employed in connection with identification of individual insureds and insurance groups for invitation for inclusion in weight control programs, administration of weight control programs, and other methods described herein, in connection with insurance policies other than group benefit policies and workers compensation policies. By way of example, methods and systems described herein may be applied in connection with automobile insurance policies.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

One or more public cloud, private cloud, hybrid cloud and cloud-like networks may also be implemented, for example, to handle and conduct processing of one or more transactions or processing of the present invention. Cloud based computing may be used herein to handle any one or more of the application, storage and connectivity requirements of the present invention. For example one or more private clouds may be implemented to handle generation of predictive models, determination of weight control scores, weight control severity scores and trends, and insurance policy discounts. Furthermore, any suitable data and communication protocols may be employed to accomplish the teachings of the present invention.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A system for determining, for selected insurance groups, a first behavior modification program for modifying a first select behavior comprising:
one or more insurance data storage devices having employee data including workers compensation class and claims data for employees of a plurality of insurance groups;
one or more insurance processors;
an insurance memory in communication with the one or more insurance processors and storing insurance program instructions, the one or more insurance processors operative with the insurance program instructions to:
select, based on at least the employee data including a workers compensation class and the claims data, one or more of the plurality of insurance groups for participation in the first behavior modification program;
select one or more employees of the one or more of the plurality of insurance groups selected for participation in the first behavior modification program; and
update a first behavior modification program membership data file for each insurance group to include information identifying the one or more employees of the one or more insurance groups selected for participation in the first behavior modification program; and
an insurance communications device for transmitting, to each of the insurance groups selected for participation in the first behavior modification program, information relating to the first behavior modification program.

2. The system of claim 1, wherein the plurality of behaviors includes weight control behavior, employee safety behavior, prescription management behavior, rehabilitation management behavior, cognitive behavior, fitness behavior, and pain management behavior.

3. The system of claim 1, wherein the one or more insurance processors are further operative with the insurance program instructions to:
determine, based on the employee data and the claims data, a group score for the first select behavior for each of the plurality of insurance groups; and
determine, using a predictive model and based on the employee data and the claims data, a trend in the group score for the first select behavior for each of the plurality of insurance groups; and
wherein the one or more of the plurality of insurance groups selected for participation in the first behavior modification program are selected based on one or both of group score for the first select behavior and the trend in the group score for the first select behavior.

4. The system of claim 3, wherein the one or more insurance processors are further operative with the insurance program instructions to:
determine, based on one or both of the group score for the first select behavior and the trend in the group score for the first select behavior, discounts available to each of the insurance groups selected for participation in the first behavior modification program; and
wherein the insurance communications device is configured to transmit the discounts available to each of the insurance groups selected for participation in the first behavior modification program.

5. The system of claim 3, wherein the group score for the first select behavior is determined based on one or both of a workers compensation experience modifier and a comparison between the employee data and the claims data and demographic employee data and demographic claims data of insurance groups in the same industry and geographic region.

6. The system of claim 1, wherein the one or more insurance processors are further operative with the insurance program instructions to:
determine, based on the employee data and the claims data for the employees of the insurance groups selected for participation in the first behavior modification program, a first behavior score for each employee; and
determine, using a predictive model and based on the employee data and the claims data, a trend in the first behavior score for each employee;
wherein the one or more employees selected for participation in the first behavior modification program are selected based on one or both of the first behavior score and the trend in the first behavior score.

7. The system of claim 6, wherein the first behavior score is determined based on one of a volatility of workers compensation or group benefit claims made by the employee within a selected time period and a severity of workers compensation or group benefit claims made by the employee within a selected time period.

8. The system of claim 1, wherein the one or more insurance processors are further operative with the insurance program instructions to identify a second select behavior from the plurality of behaviors for which a second behavioral modification program will be provided to selected insurance groups, wherein identification of the second select behavior is based upon a known co-morbidity between the second select behavior and the first select behavior.

9. The system of claim 1, wherein the information relating to the first behavior modification program transmitted to the insurance groups selected for participation in the first behavior modification program includes targeted information relating to one or more of: patient education materials relating to the first behavior; medical professionals specializing in treating the first behavior; medical procedures relating to the first behavior; and risk factors relating to the first behavior.

10. The system of claim 1, further comprising:
an administrative processor;
an administrative communications device for transmitting and receiving data relating to the first behavior modification program;
an administrative memory in communication with the administrative processor and storing administrative program instructions, the administrative processor operative with the administrative program instructions to:
receive from the insurance processor the first behavior modification program membership data file for each of the one or more insurance groups selected for participation in the first behavior modification program;
provide access to the first behavior modification program, through employee devices communicatively connected to the administrative processor, to the selected employees in the first behavior modification program membership data file;
track usage of the first behavior modification program on the employee devices by the selected employees; and
transmit, via the administrative communications device, the usage data to the one or more insurance processors.

11. The system of claim 10, wherein the one or more insurance processors are further operative with the insurance program instructions to: receive, via the insurance communications device, workers compensation experience modifier data for a time period after completion of the first behavioral modification program by an insurance group;
determine, based on the workers compensation experience modifier data, a first behavioral modification program effectiveness score for one or both of an employee enrolled in the first behavioral modification program or an insurance group that participated in the first behavioral modification program; and
determine, based on the first behavioral modification program effectiveness score, discounts available to each of the insurance groups selected for participation in the first behavioral modification program.

12. A computer-implemented method for determining a first behavioral modification program for a first select behavior to provide to insurance groups comprising:
selecting, by a processor, the first behavior from a plurality of behaviors;
selecting, using the processor and based on employee data including the workers compensation class and claims data, one or more of a plurality of insurance groups for participation in the first behavioral modification program;
selecting, by the processor, one or more employees of the one or more of the plurality of insurance groups selected for participation in the first behavioral modification program;
updating, using the processor, a first behavioral modification program membership data file for each insurance group to include information identifying the one or more employees of the one or more of the plurality of insurance groups selected for participation in the first behavioral modification program; and
transmitting, using an insurance communications device, to each of the insurance groups selected for participation in the first behavioral modification program, information relating to the first behavioral modification program.

13. The computer-implemented method of claim 12, further comprising:
determining, using the processor and based on the employee data and the claims data, a group score for the first select behavior for each of the plurality of insurance groups; and
determining, using the processor and a predictive model and based on the employee data and the claims data, a trend in the group score for the first select behavior for each of the plurality of insurance groups; and
wherein the one or more of the plurality of insurance groups selected for participation in the first behavior modification program are selected based on one or both of group score for the first select behavior and the trend in the group score for the first select behavior.

14. The computer-implemented method of claim 12, further comprising:
determining, using the processor and based on the employee data and the claims data for the employees of the insurance groups selected for participation in the first behavior modification program, a first behavior score for each employee; and
determining, using the processor and a predictive model and based on the employee data and the claims data, a trend in the first behavior score for each employee;
wherein the one or more employees selected for participation in the first behavior modification program are selected based on one or both of the first behavior score and the trend in the first behavior score.

15. The computer-implemented method of claim 12, further comprising identifying, using the processor, a second select behavior from the plurality of behaviors for which a second behavioral modification program will be provided to the one more insurance groups selected for participation in the first behavior modification program, wherein identification of the second select behavior is based upon a co-morbidity between the second select behavior and the first select behavior.

16. The computer-implemented method of claim 12, wherein transmitting the information relating to the first behavior modification program to the one or more insurance groups selected for participation in the first behavior modification program comprises transmitting targeted information relating to one or more of: patient education materials relating to the first behavior; medical professionals specializing in treating the first behavior; medical procedures relating to the first behavior; and risk factors relating to the first behavior.

17. The computer-implemented method of claim 12, further comprising:
receiving by an administrative communications device the first behavior modification program membership data file for each insurance group selected for participation in the first behavior modification program;
providing, using an administrative processor, access to the first behavioral modification program through employee devices communicatively connected to the administrative processor, to the selected employees in the first behavioral modification program membership data file;
tracking, using the administrative processor, usage of the first behavioral modification program on the employee devices by the selected employees; and
transmitting, via the administrative communications device, the usage data to the one or more insurance processors.

18. A non-transitory computer readable medium having stored therein instructions that, upon execution, cause a computer processor to:
select, using a processor, a first behavior from a plurality of behaviors;
select, using the processor and based on employee data including the employee workers compensation class and claims data, one or more of a plurality of insurance groups for participation in the first behavioral modification program;
select, by the processor, one or more employees of the one or more plurality of insurance groups selected for participation in the first behavioral modification program;
update, using the processor, a first behavioral modification program membership data file for each insurance group to include information identifying the one or more employees of the one or more insurance groups selected for participation in the first behavioral modification program; and
transmit, using an insurance communications device, to each of the insurance groups selected for participation in the first behavioral modification program, information relating to the first behavioral modification program.

19. The non-transitory computer readable medium of claim 18, wherein the instructions further cause the computer processor to:
determine, using the processor and based on the employee data and the claims data, a group score for the first select behavior for each of the plurality of insurance groups; and
determine, using the processor and a predictive model and based on the employee data and the claims data, a trend in the group score for the first select behavior for each of the plurality of insurance groups;
determine, using the processor and based on the employee data and the claims data for the employees of the insurance groups selected for participation in the first behavior modification program, a first behavior score for each employee; and
determine, using the processor and a predictive model and based on the employee data and the claims data, a trend in the first behavior score for each employee;
wherein the one or more of the plurality of insurance groups selected for participation in the first behavior modification program are selected based on one or both of group score for the first select behavior and the trend in the group score for the first select behavior; and
wherein the one or more employees selected for participation in the first behavior modification program are selected based on one or both of the first behavior score and the trend in the first behavior score.

20. The non-transitory computer readable medium of claim 18, wherein the instructions further cause the computer processor to:
receive by an administrative communications device the first behavior modification program membership data file for each insurance group selected for participation in the first behavior modification program;
provide, using an administrative processor, access to the first behavioral modification program through employee devices communicatively connected to the administrative processor, to the selected employees in the first behavioral modification program membership data file;
track, using the administrative processor, usage of the first behavioral modification program on the employee devices by the selected employees; and
transmit, via the administrative communications device, the usage data to the one or more insurance processors.
